(19) United States
(12) Patent Application Publication
(10) Pub. No.: US 2007/0197192 A1
(43) Pub. Date: Aug. 23, 2007

(54) METHOD FOR EXECUTING ELECTRONIC TRANSACTIONS USING A MOBILE COMMUNICATION DEVICE

(76) Inventor: Yu-Hui Cho, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/675,625

(22) Filed: Feb. 15, 2007

(30) Foreign Application Priority Data
Feb. 22, 2006 (TW) 095105965

(51) Int. Cl. H04M 1/66

(52) U.S. Cl. 455/411

(57) ABSTRACT

A method for executing an electronic transaction includes a mobile communication device reading a finance transaction card; inputting a security code into the mobile communication device for transmitting the security code to a service end; when the security code matches a predetermined code, the mobile communication device delivers a set of transaction data to the service end; the service end generates an set of authorization data according to data from the mobile communication device, the service end transmitting the set of authorization data to the mobile communication device, the set of authorization data including an authorization code; and the mobile communication device forwarding the authorization code to a merchant end.

### BACKGROUND OF THE INVENTION

1. Field of the Invention

The present invention provides a method for executing an electronic transaction, and more particularly, a method for executing an electronic transaction using a mobile communication device.

2. Description of the Prior Art

As the technology progresses, the electronic transactions have become one of the methods for paying. For example, a consumer browses items of a shopping website and enters his personal data and credit card data to the shopping website when he buys things. The website transmits the data entered by the consumer to a credit card transaction center for verification, and obtains the authorization data, which is an authorization code, from the credit card transaction center. In this way, the electronic transaction is completed. In the procedures described above, the consumer's personal data and credit card data are insecure since they are transmitted through the shopping website to the credit card transaction center. In this way, the consumer faces the risk of exposure of the personal data and the credit card data.

In addition, consumers also buy things or obtain service with the card with electronic money adding function such as easy cards or travel cards. However when the amount of money in the card is insufficient, the consumer has to bring the card and cash to a specific location for adding money in, causing inconvenience to the consumer.

### SUMMARY OF THE INVENTION

It is therefore an objective of the claimed invention to provide a method of executing an electronic transaction using a mobile communication device in order to solve the above-mentioned problems.

A method for executing an electronic transaction using a mobile communication device including five steps which are (a) a mobile communication device reading a transaction card, (b) inputting a security code in the mobile communication device for enabling the mobile device to transmit the security code to a service end, (c) the mobile device transmitting a set of transaction data to the service end when the code matches a predetermined code, (d) the service end generating a set of authorization data transmitted to the mobile communication device in response to receiving the set of transaction data in (c), wherein the set of authorization data comprises an authorization number, and (e) the mobile communication device transmitting the authorization number to a merchant end.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic transaction using a mobile communication device of the present invention.

FIG. 2 is a diagram of another electronic transaction using a mobile communication device of the present invention.

FIG. 3 is a flowchart of an electronic transaction using a mobile communication device of the present invention.

### DETAILED DESCRIPTION

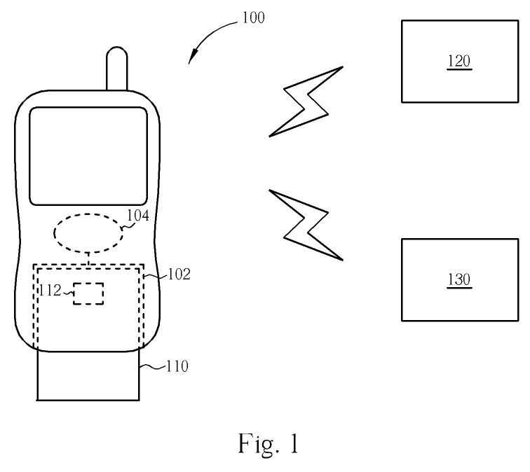

Please refer to FIG. 1. FIG. 1 is a diagram showing the mobile communication device 100 of the present invention executing an electronic transaction. The mobile communication device 100 of the present invention is equipped with a card-reading device 102 for reading a transaction card 110. In the embodiment in FIG. 1, the transaction card 110 can be a credit card with a Java IC or any other types of IC. A Java-IC card is capable of not only encrypting data but also storing a great deal of personal data and application programs. Thus the Java-IC card is widely applied to cards with electronic money adding function, IC credit cards, and identification IC cards. The transaction card 110 can execute electronic transactions with the mobile communication device 100 as long as the mobile communication device 100 is in the service range.

For instance, when a consumer pays a bill, he couples to a service end 120, e.g. the server of the credit card transaction center, through the mobile communication device 100 by utilizing the card-reading device 102 of the mobile communication device 100 of the present invention for reading the credit card 110. Meanwhile, the consumer has to enter a security code into the mobile communication device 100 and transmit the code to the server 120 of the credit card transaction center. If the code matches a predetermined code, the transaction passes the verification of the credit card transaction center and proceeds further. Instead, if the code does not match the predetermined code, the transaction will be cancelled. After passing the verification, the consumer enters a set of transaction data such as an amount of money for the transaction into the mobile communication device 100, and the system 104 of the mobile communication device 100 transmits the set of transaction data to a Java-IC card 112. The Java-IC card sends the set of transaction data back to the mobile communication device 100 after encrypting the set of transaction data with the encrypting function of the Java-IC card. In the embodiment of the present invention, the system 104 of the mobile communication device 100 encrypts the set of encrypted transaction data again according to a specific protocol and attaches a header of the specific protocol for transmitting the set of double-encrypted transaction data to the credit card transaction center with higher security. However, the mobile communication device 100 also can transmit the set of transaction data encrypted by the Java-IC card 112 directly to the server 120 of the credit card transaction center.

When the server 120 of the credit card transaction center receives the transaction data transmitted from the mobile communication device 100, the server 120 of the credit card transaction center reads the header of the specific protocol to decrypt the transaction data. After decrypting the transaction data, the server 120 of the credit card transaction center generates a set of authorization data in response to the transaction data, encrypts the set of authorization data according to the specific protocol, and attaches a header of the specific protocol for higher security. Then, the server 120 of the credit card transaction center transmits the set of authorization data attached with the header of the specific protocol to the mobile communication device 100. When the mobile communication device 100 receives the authorization data from the server 120 of the credit card transaction center, the system 104 of the mobile communication device 100 also reads the header of the specific protocol to decrypt the authorization data. The protocols used in encrypting the transaction data and in encrypting the authorization data can be the same or not. After decrypting the authorization data, the mobile communication device 100 knows if the transaction succeeds. For example, if the amount of money of the transaction exceeds the credit of the consumer, the authorization will not succeed, and the transaction will be cancelled. When the transaction succeeds, the mobile communication device 100 obtains an authorization code from the authorization data, and the system 104 of the mobile communication device 100 transmits the authorization code to the merchant end 130 for paying the bill. For instance, if a consumer shops on the internet through the mobile communication device 100, after the mobile communication device 100 obtains the authorization code, the consumer uses the mobile communication device 100 to transmit the authorization code to the shopping website for validating the payment. If a consumer shops in a supermarket, after the mobile communication device 100 obtains the authorization code, the consumer uses the mobile communication device 100 to transmit the authorization code to a cashier for validating the payment. The method for transmitting the authorization code to a cashier with the mobile communication device 100 is achieved with the radio transmission techniques, e.g. Bluetooth techniques or infrared techniques. Furthermore, if the transaction is valid (the amount of money of the transaction is lower than the credit of the consumer), the amount of money of the transaction is recorded (deducted) in the consumer's account when the server 120 of the credit card transaction center generates the transaction data.

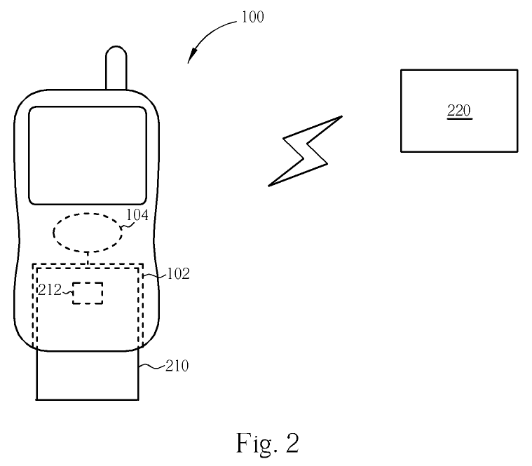

Please refer to FIG. 2. FIG. 2 is a diagram illustrating another electronic transaction proceeded with the mobile communication device 100 in FIG. 1. In the embodiment in FIG. 2, the transaction card 210 is a card with electronic money adding function including a Java-IC card 212 or any other type of IC card. The consumer uses the mobile communication device 100 to store money in the card 210 as long as the mobile communication device 100 is in the service range.

For example, when the amount of money in the card 210 is insufficient, the consumer uses the card-reading device 102 of the mobile communication device 100 of the present invention to read the card 210 for connecting to a service end 220, e.g. the server of a bank. Meanwhile, the consumer has to enter a security code into the mobile communication device 100 for transmitting the code to the server 220. If the code matches a predetermined code, the transaction passes the verification of the server 220 and proceeds further. Instead, if the code does not match the predetermined code, the transaction fails to pass the verification of the server 220 of the bank and is cancelled. After passing the verification, the consumer enters a set of transaction data such as the amount of the money supplied in the electronic card 210 of the mobile communication device 100, and the system 104 of the mobile communication device 100 transmits the set of transaction data to the Java-IC card 212. As described above, Java-IC card 212 can encrypt data so that the set of transaction data is encrypted and sent back to the mobile communication device 100. In the embodiment of the present invention, the system 104 of the mobile communication device 100 encrypts the set of the encrypted transaction data again according to a specific protocol, and attaches a header of the specific protocol to the data for transmitting to the server 220 with higher security. However, the mobile communication device 100 transmits the set of transaction data encrypted by the Java-IC card 212 directly to the server 220.

When the server 220 receives the transaction data from the mobile communication device 100, the server 220 reads the header of the specific protocol to decrypt the transaction data. After decrypting the transaction data, the server 220 generates a set of authorization data according to the transaction data, encrypts the authorization data according to the specific protocol, and attaches a header of the specific protocol for higher security. Then, the server 220 of the bank transmits the set of authorization data with the header of the specific protocol to the mobile communication device 100. When the mobile communication device 100 receives the authorization data from the server 200, the system 104 of the mobile communication device 100 reads the header of the specific protocol to decrypt the authorization data. The protocols used in encrypting the transaction data and in encrypting the authorization data can be the same protocols or not. After decrypting the authorization data, the mobile communication device 100 knows if the authorization succeeds. For example, if the money supplement is more than the amount deposited in the consumer's account, the authorization does not succeed, and the transaction is cancelled. When the authorization succeeds, the system 104 of the mobile communication device 100 updates the amount of money stored in the card 210 (stores the amount of the money supplement in the card 210) according to the authorization data. Furthermore, if the transaction above is valid (the amount of the money supplement is lower than the amount deposited in the consumer's account), the amount of money deducts from the consumer's account when the server 220 generates the set of authorization data.

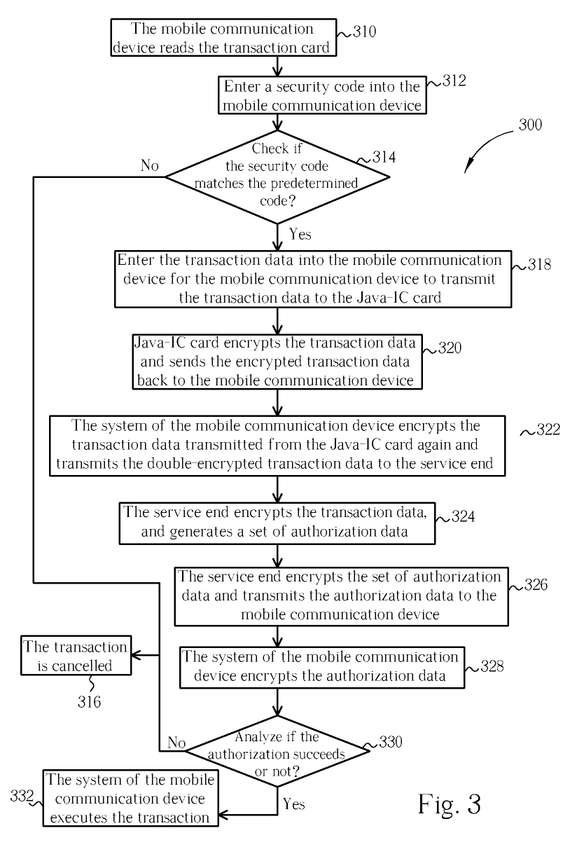

For more clearly illustrating the method for executing an electronic transaction with the mobile communication device 100 of the present invention, FIG. 3 shows a flow-chart 300 of the present invention. Please refer to FIG. 3, together with FIG. 1 and FIG. 2. The flowchart 300 includes the following steps:

step 310: the mobile communication device 100 reads the transaction card 110 (or 210);

step 312: enter a security code into the mobile communication device 100 to enable the mobile communication device 100 to transmit the security code to the service end 120 (or 220);

step 314: check if the security code matches the predetermined code. If so, continue on to step 318, if not, continue with step 316;

step 316: the transaction is cancelled;

step 318: enter the transaction data into the mobile communication device 100 for the mobile communication device 100 to transmit the transaction data to the Java-IC card 112 (or 212);

step 320: Java-IC card 112 (or 212) encrypts the transaction data and sends the encrypted transaction data back to the mobile communication device 100;

step 322: the system 104 of the mobile communication device 100 encrypts the transaction data transmitted from the Java-IC card 112 (or 212) again according to a specific protocol, attaches a header of the specific protocol, and transmits the double-encrypted transaction data to the service end 120 (or 220);

step 324: the service end 120(or 220) reads the header of the specific protocol to decrypt the transaction data, and generates a set of authorization data according to the transaction data;

step 326: the service end 120 (or 220) encrypts the set of authorization data according to the specific protocol, attaches a header of the specific protocol, and transmits the authorization data to the mobile communication device 100;

step 328: the system 104 of the mobile communication device 100 reads the header of the specific protocol to decode the authorization data;

step 330: analyze if the authorization succeeds or not, if so, continue with step 332; if not, continue with step 316;

step 332: the system 104 of the mobile communication device 100 executes the transaction such as transmitting an authorization number to a merchant end 130 for paying bills or storing the money supplement in the electronic stored-value card 210.

Basically, to achieve the same result, the steps of the flowchart 300 need not be in the exact order shown and need not be contiguous, that is, other steps can be intermediate. Additionally, the method of the present invention can be achieved by means of software, software with firmware, or hardware.

Compared with the prior art, the present invention provides a method for executing an electronic transaction with the mobile communication device 100. The consumer utilizes the mobile communication device 100 to obtain the authorization of the credit card transaction center so that the personal and credit data avoid running the risk of exposure because the personal and credit card data of the consumer do not have to transmit to the credit card transaction center through a third party. Furthermore, when the money stored in the card 210 is insufficient, the consumer can add the money in the card 210 with the mobile communication device right away, which increases the convenience for the consumer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for executing an electronic transaction using a mobile communication device, the method comprising:
(a) a mobile communication device reading a transaction card;
(b) inputting a security code in the mobile communication device for enabling the mobile device to transmit the security code to a service end;
(c) the mobile device transmitting a set of transaction data to the service end when the code matches a predetermined code;
(d) the service end generating a set of authorization data transmitted to the mobile communication device in response to receiving the set of transaction data in (c), wherein the set of authorization data comprises an authorization code; and
(e) the mobile communication device transmitting the authorization code to a merchant end.

2. The method of claim 1, further comprising the mobile communication device encrypting the set of transaction data, wherein the encrypted set of transaction data is transmitted by the mobile communication device to the service end if the security code matches the predetermined code.

3. The method of claim 2, wherein the mobile communication device encrypts the set of transaction data according to a specific protocol and attaches a header of the specific protocol to the set of transaction data.

4. The method of claim 2, further comprising the service end decrypting the set of encoded transaction data.

5. The method of claim 1, further comprising the service end encrypting the set of transaction data, wherein the set of authorization data in (d) is generated according to the transaction data transmitted in (c), and the service end transmits the set of encrypted authorization data which comprises the authorization code to the mobile communication device.

6. The method of claim 5, wherein the service end encrypts the set of authorization data according to a specific protocol and attaches a header of a specific protocol to the set of authorization data.

7. The method of claim 5, further comprising the mobile communication device decrypting the set of encrypted authorization data.

8. The method of claim 1, wherein the transaction card is a credit card with a Java IC.

9. A method for executing an electronic transaction using a mobile communication device, the method comprising:
(a) a mobile communication device reading a transaction card;
(b) inputting a security code in the mobile communication device for enabling the mobile device to transmit the security code to a service end;
(c) the mobile device transmitting a set of transaction data to the service end when the code matches a predetermined code;
(d) the service end generating a set of authorization data transmitted to the mobile communication device in response to receiving the set of transaction data in (c), wherein the set of authorization data comprises an authorization code; and
(e) the mobile communication device updating the data stored in the transaction card in response to the authorization result.

10. The method of claim 9, further comprising the mobile communication device encrypting the set of transaction data, wherein the set of transaction data is transmitted by the mobile communication device to the service end if the security code matches the predetermined code.

11. The method of claim 10, wherein the mobile communication device encrypts the set of transaction data according to a specific protocol and attaches a header of the specific protocol to the set of transaction data.

12. The method of claim 10, further comprising the service end decrypting the set of encoded transaction data.

13. The method of claim 9, further comprising the service end encrypting the set of transaction data, wherein the set of authorization data in (d) is generated in response to receiving the transaction data transmitted in (c), and the service end transmits the set of encrypted authorization data which comprises the authorization code to the mobile communication device.

14. The method of claim 13, wherein the service end encrypts the set of authorization data according to a specific protocol and attaches a header of a specific protocol to the set of authorization data.

15. The method of claim 13, further comprising the mobile communication device decoding the set of encrypted authorization data.

16. The method of claim 9, wherein the transaction card is a credit card with a Java IC.
